(19) United States
(12) Patent Application Publication
(10) Pub. No.: US 2020/0146792 A1
(43) Pub. Date: May 14, 2020

(54) Wearable Interdental Cleaning Apparatus

(71) Applicants: Michael Chang, Saratoga, CA (US); Kuo Tung Chang, Saratoga, CA (US)

(72) Inventors: Michael Chang, Saratoga, CA (US); Kuo Tung Chang, Saratoga, CA (US)

(73) Assignee: UMECK LLC, Saratoga, CA (US)

(21) Appl. No.: 16/190,185

(22) Filed: Nov. 14, 2018

(51) Int. Cl. A61C 15/02

(52) U.S. Cl. CPC A61C 15/02

(57) ABSTRACT

This invention relates to a finger wearable interdental cleaning apparatus comprising finger hooks and attachable toothpick. The finger hooks are mounted on finger joint areas with the toothpick being attached to the body of the finger hooks. By using finger joint areas to control the movement of the toothpick, it frees up the finger tips for holding the toothpick such that all fingers can be used to cover the mouth area when using the toothpick. The mouth area is covered by the same hand operating the toothpick. It eliminates the need to use the second hand to cover the mouth area when the first hand is operating the toothpick. This makes the tooth cleaning more convenient and better etiquette.

### BACKGROUND OF THE INVENTION

### Field of the Invention

The present application relates to interdental cleaning apparatus.

### Background of the Invention

For interdental cleaning, different types of toothpick brushes have been available. Their core structures are either made of twisted wires or thermoplastic materials. The cleaning element of these toothpick brushes usually include various type of bristles, nubs, or protrusions. For these existing toothpick brushes, there is a handle portion for two or three fingers to pinch and control the movement of the toothpick brushes. During the tooth cleaning, especially for reaching the rear teeth such as molars, usually the mouth needs to be twisted for easy access of the interdental areas. Sometimes the teeth may be exposed to other people if it is in public area. It is good etiquette to apply the other hand to cover the mouth area such that the distorted mouth or teeth are not exposed to the public. FIG. 1 shows the conventional way of using two hands for operating the toothpick brush, with left hand covering the mouth area while the right hand is operating the toothpick brush. This is inconvenient since the second hand may be holding something in certain situations while the first hand is using the toothpick brush. The objective of this invention is to have an interdental cleaning apparatus which allows the distorted mouth to be blocked by the same hand operating the toothpick brush, such that the other hand is freed for other use.

### SUMMARY OF THE INVENTION

In order to achieve the above-mentioned objectives, a finger wearable interdental cleaning apparatus having finger hooks and attachable toothpick is disclosed. By attaching the toothpick to the body of the finger hooks and mounting the finger hooks to the finger joint area, this invention allows one to operate the toothpick by using finger joint areas instead of finger tips. Since the finger tips are no longer required to hold and operate the toothpick, all the fingers are freed up and can be used to cover the mouth area while cleaning the teeth. It eliminates the need to use the second hand to cover the mouth area when the first hand is operating the toothpick. FIG. 2 illustrates an example of this invention when mounting on the finger joint area. FIG. 3 shows how it looks like when using this invention for tooth cleaning. The mouth area is hidden behind the same hand operating the toothpick such that the distorted mouth is not exposed to the public. This achieves the objectives of this invention.

The finger hooks in this invention consist of at least one primary hook, at least one secondary hook, and a body connecting the primary and secondary hooks. The body includes a hole preferred with threading for attaching a threaded shaft of an attachable toothpick. The finger hooks can be mounted adjacent to the finger joint areas. The primary hooks are mounted on the palm side of fingers, and the secondary hooks are mounted on the back side of fingers. The body is placed between two fingers. Either the index finger, middle finger, ring finger, combination of index and middle fingers, or combination of middle and ring fingers can be used to mount the finger hooks. Typically, but not limited to, the finger hooks can be made of metal, wood, thermoplastic materials, or synthetic rubber such as silicone.

The attachable toothpick is composed of a shaft and a cleaning element. Typically, but not limited to, the shaft is made of thermoplastic material, and the cleaning element is made of soft synthetic rubber such as silicone. The shaft includes a cleaning portion, a grip portion, and an attachment portion. The cleaning portion is at distal end of the shaft, and its outer surface including the distal end area is covered by a thin layer of cleaning element which is made of synthetic rubber. The cleaning element and the cleaning portion can be inserted into the interdental area for tooth cleaning and gum massage. The grip portion provides the support of the cleaning portion and is used for gripping the toothpick to attach to the finger hooks. The attachment portion is at the opposite distal end of the shaft and is used for attaching the toothpick to the finger hooks. In preferred embodiment, the attachment portion includes threading.

### BRIEF DESCRIPTION OF THE DRAWINGS

FIG. 1 shows the conventional way of using toothpick with two hands for better etiquette when in public, the right hand operates the toothpick and the left hand covers the mouth area.

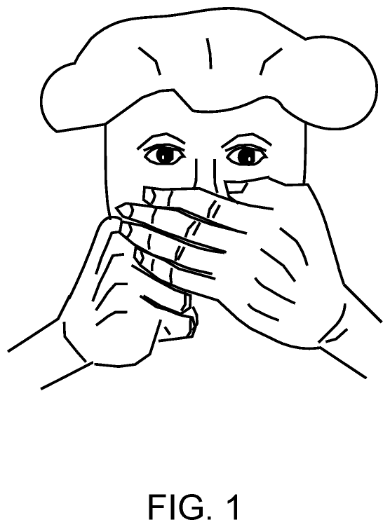

FIG. 2 shows an example of this invention mounting on the middle and ring fingers.

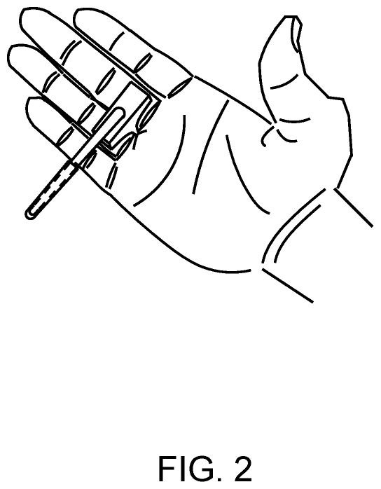

FIG. 3 illustrates the use of this invention. Only one hand is needed to cover the mouth area while operating the toothpick.

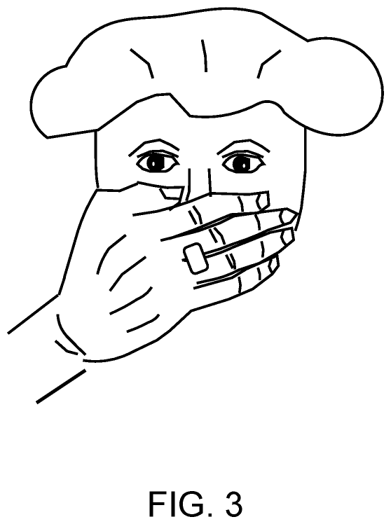

FIG. 4 shows perspective view of the finger hooks and attachable toothpick in this invention.

FIG. 5A and FIG. 5B show details of the preferred embodiment of the finger hooks in this invention.

FIG. 6A and FIG. 6B show details of another embodiment of the finger hooks in this invention.

FIG. 7 shows the details of the attachable toothpick in this invention.

FIG. 8 shows details of another embodiment of the toothpick in this invention.

### DETAILED DESCRIPTION OF THE EMBODIMENT

A description is provided of a preferred embodiment of the invention with reference to the attached drawings.

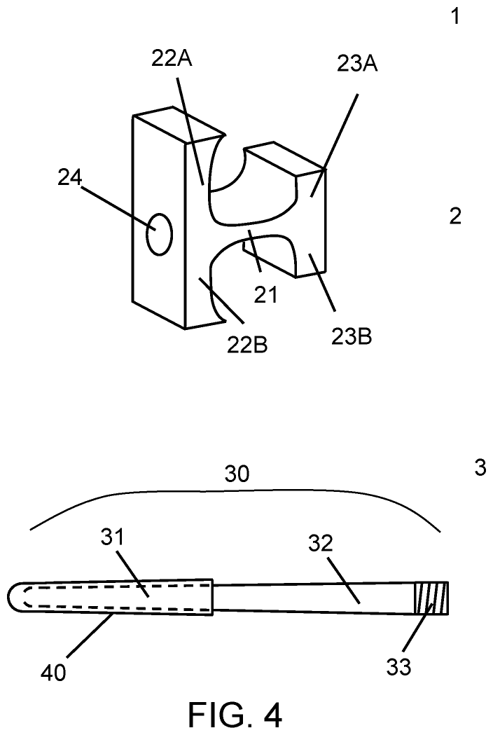

The finger hooks in this invention consist of at least one primary hook, at least one secondary hook, and a body connecting the primary and secondary hooks. The body includes a hole preferred with threading for attaching a threaded shaft of an attachable toothpick. FIG. 4 illustrated the interdental cleaning apparatus 1 which consists of finger hooks 2 and an attachable toothpick 3. In preferred embodiment, the finger hooks include two primary hooks 22A and 22B and two secondary hooks 23A and 23B. They can be mounted on either index and middle fingers or middle and ring fingers. The finger hooks 2 have a body 21 connecting the primary hooks 22A, 22B, and secondary hooks 23A and 23B. The body 21 includes at least a hole 24 for attaching the toothpick 3. Typically the secondary hooks 23A and 23B are shorter or smaller than the primary hooks 22A and 22B. The primary hooks 22A and 22B are used to mount on the palm side of the finger joint areas of the index and middle fingers or middle and ring fingers. The secondary hooks 23A and 23B are used to mounted on the back side of the finger joint areas of the index and middle fingers or middle and ring fingers. The finger joint areas include the metacarpophalangeal, proximal interphalangeal, and distal interphalangeal. The body 21 is placed in between either index and middle fingers or middle and ring fingers depending on which fingers the primary and secondary hooks are mounted. The hole 24 includes threading which is used to attach the toothpick 3. The finger hooks can be made of metal, wood, thermoplastic material, or synthetic rubber such as silicone. The toothpick 3 has a shaft 30 and cleaning element 40. The shaft 30 includes a cleaning portion 31, a grip portion 32, and an attachment portion 33. The attachment portion 33 includes threading for fitting the threaded hole 24. The cleaning element 40 is made of a thin layer of soft synthetic rubber such as silicone, which is coated on the outside surface of the cleaning portion 31 including the distal end area.

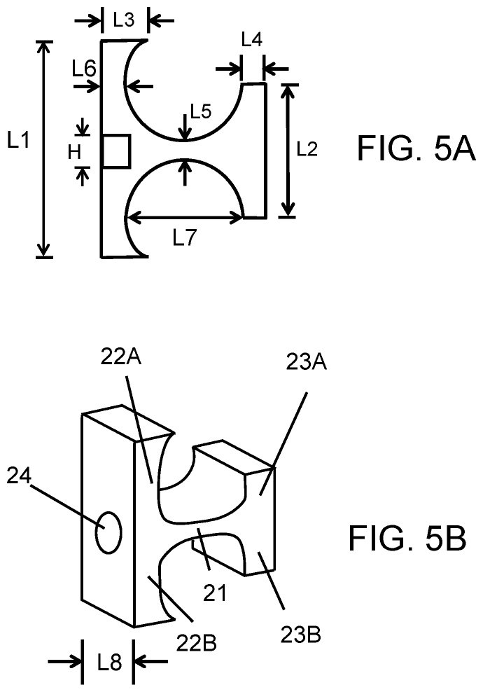

FIG. 5A and FIG. 5B show the details of the preferred embodiment of the finger hooks. As shown in FIG. 5A, the length of L1 is 20 mm to 50 mm, length of L2 is 10 mm to 20 mm, length of L3 is 2 mm to 7 mm, length of L4 is 2 mm to 5 mm, length of L5 is 0.5 mm to 2 mm, length of L6 is 2 mm to 4 mm, length of L7 is 15 mm to 30 mm, and the diameter H of the hole 24 is 1 mm to 4 mm. As shown in FIG. 5B, length of L8 is 4 mm to 10 mm. In one of the embodiments of the invention, length of L3 is the same as L6.

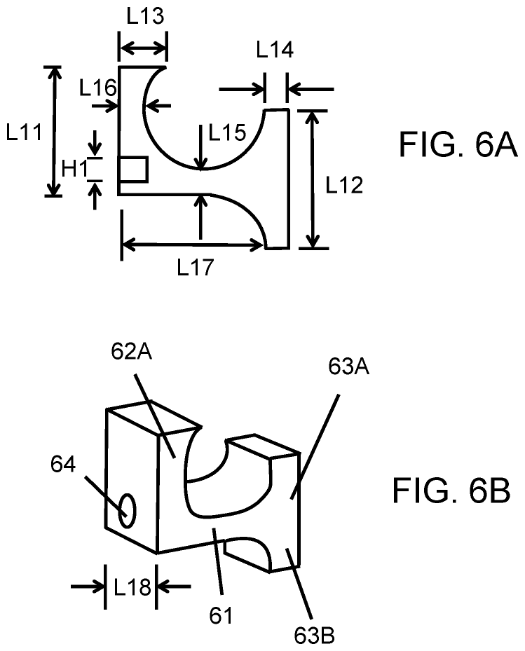

In another embodiment of the finger hooks 6 as shown in FIG. 6A and FIG. 6B, only one primary hook 62A is used to mount on the palm side of the index, middle, or ring finger. To secure the mounting of the finger hooks, both secondary hooks 63A and 63B are used. As shown in FIG. 6A, the length of L11 is 20 mm to 30 mm, length of L12 is 10 mm to 20 mm, length of L13 is 2 mm to 7 mm, length of L14 is 2 mm to 5 mm, length of L15 is 0.5 mm to 2 mm, length of L16 is 2 mm to 4 mm, length of L17 is 15 mm to 35 mm, and the diameter H1 of the hole 64 is 1 mm to 4 mm. As shown in FIG. 6B, length of L18 is 4 mm to 10 mm. In another embodiment of the invention, length of L13 is the same as L16.

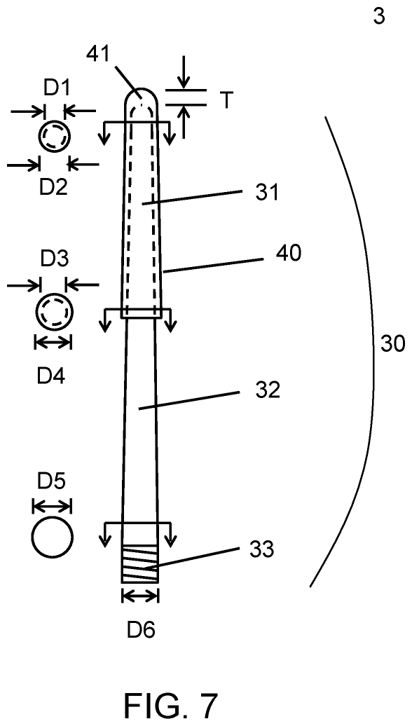

The attachable toothpick is composed of a shaft and a cleaning element. Typically, but not limited to, the shaft is made of thermoplastic material, and the cleaning element is made of soft synthetic rubber such as silicone. FIG. 7 shows the details of the preferred embodiment of the toothpick 3 which has a shaft 30 and cleaning element 40. The shaft 30 includes a cleaning portion 31, a grip portion 32, and an attachment portion 33. The cleaning portion 31 is at the distal end of the shaft 30. The attachment portion 33 is at the opposite distal end of the shaft 30. The grip portion 32 is in between the cleaning portion 31 and the attachment portion 33. The cleaning portion 31 and the grip portion 32 forms a spear tip rod. The cleaning portion 31 is used for coating a cleaning element 40 and can be inserted into the interdental area for food residual removal and gum massage. The grip portion provides the support for the cleaning portion 31 and allows for fingers to grip during mounting of the toothpick to the finger hooks. The attachment portion 33 is used to attach the toothpick 3 to the finger hooks 2. The cross-section diameter of the shaft 3 is smallest at distal end and gradually increases toward the grip portion 32 along the longitudinal axis of the shaft 3. The diameter of the grip portion 32 also gradually increases toward the attachment portion 33 with the same rate as the cleaning portion 31. The diameter D1 of the cleaning portion 31 at distal end is 0.4 mm to 0.6 mm. The diameter D3 at boundary between the cleaning portion 31 and the grip portion 32 is 1 mm to 1.4 mm. The diameter D5 at boundary between the grip portion 32 and the attachment portion 33 is 1.6 mm to 2.2 mm. D5 is also the largest diameter of the grip portion. In preferred embodiment, the cross-section diameter D6 of the attachment portion 33 is the same as the largest diameter D5 of the grip portion 32. In another embodiment, the cross-section diameter D6 of the attachment portion 33 is larger than the largest diameter D5 of the grip portion 32. In preferred embodiment, the total length of the shaft 3 is 40 mm to 60 mm. The length of the cleaning portion 31 and the grip portion 32 is 16 mm to 22 mm, respectively. The length of the attachment portion 33 is 3 mm to 6 mm. In preferred embodiment, the attachment portion 33 includes threading to fit the threaded hole 24 on the finger hooks. As shown in FIG. 7, The outer surface and the distal end of the cleaning portion 31 is coated with the cleaning element 40 which is made of soft synthetic rubber such as silicone. Typical thickness of the soft synthetic rubber of the cleaning element 40 on sidewall of cleaning portion is 0.1 mm to 0.2 mm. The thickness T of the synthetic rubber extending out of the distal end 41 of the cleaning portion is 0.5 mm to 1.0 mm.

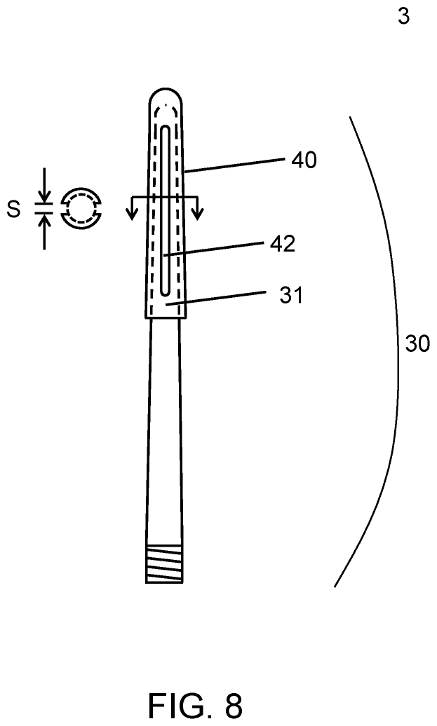

In another embodiment of the invention as shown in FIG. 8, the cleaning element 40 includes a slot 42 on the two opposite sides of the circumstance of the cleaning portion 31. The slot 42 is aligned along the longitudinal axis of the shaft 3. The width of the slot S is 0.1 mm to 0.3 mm, and the length of slot 42 is more than 50% and less than 90% of the length of the cleaning portion 31. The purpose of the slot 42 is to provide extra space for food residue and fluid movement during the tooth cleaning.

What is claimed is:

1. A wearable interdental cleaning apparatus is composed of:
at least one primary hook, said primary hooks can be mounted on palm side of fingers;
at least one secondary hook, said secondary hooks can be mounted on back side of fingers; and
a body, said body connects the primary hooks and secondary hooks, and said body can be attached by a toothpick for tooth cleaning.

2. The apparatus in claim 1 in which the body includes a hole for attaching a toothpick.

3. The apparatus in claim 1 in which the body includes a hole with threading for attaching a toothpick.

4. The apparatus in claim 1 in which the length of the primary hooks is longer than the length of the secondary hooks.

5. The apparatus in claim 1 in which said fingers include two fingers with combination of index finger and middle finger.

6. The apparatus in claim 1 in which said fingers include two fingers with combination of middle finger and ring finger.

7. The apparatus in claim 1 in which said fingers include one of the index finger, middle finger, or ring finger.

8. The apparatus in claim 1 in which said fingers further include the finger joint areas such as metacarpophalangeal, proximal interphalangeal, and distal interphalangeal.

9. The apparatus in claim 1 in which there are two primary hooks; said first primary hook is mounted on palm side of index finger and second primary hook is mounted on palm side of middle finger.

10. The apparatus in claim 1 in which there are two primary hooks; said first primary hook is mounted on palm side of middle finger and second primary hook is mounted on palm side of ring finger.

11. The apparatus in claim 1 in which there are two secondary hooks; said first secondary hook is mounted on back side of index finger and second secondary hook is mounted on back side of middle finger.

12. The apparatus in claim 1 in which there are two secondary hooks; said first secondary hook is mounted on back side of middle finger and second secondary hook is mounted on back side of ring finger.

13. The apparatus in claim 1 in which there are two primary hooks; the length of the first primary hook is different from the length of the second primary hook.

14. The apparatus in claim 1 in which there are two secondary hooks; the length of the first secondary hook is different from the length of the second secondary hook.

15. The apparatus in claim 1 in which there is one primary hook and two secondary hooks.

16. A toothpick is composed of:
a shaft; said shaft includes a cleaning portion at the distal end of the shaft, a grip portion extended from the cleaning portion, and an attachment portion at opposite distal end of the shaft, said at least part of the attachment portion includes threading; and
a cleaning element, said cleaning element covers the outer surface of the cleaning portion including the distal end of the shaft, said cleaning element is made of soft synthetic rubber such as silicone.

17. The apparatus in claim 16 in which the cleaning portion and the grip portion form a spear tip rod with smallest diameter near the distal end and gradually increases along the longitudinal axis of the shaft; reaches the largest diameter at boundary between the grip portion and the attachment portion.

18. The apparatus in claim 16 in which the cross-section diameter of the attachment portion is the same as the largest cross-section diameter of the grip portion.

19. The apparatus in claim 16 in which the cross-section diameter of the attachment portion is larger than the largest cross-section diameter of the grip portion.

20. The apparatus in claim 16 in which the cleaning element has at least one slot on each side of the two opposite sides of the outer circumstance of said cleaning portion, said slot is elongated along the longitudinal axis of the shaft, said length of the slot is more than 50% and less than 90% of the length of said cleaning portion.
